(19) United States
(12) Patent Application Publication
(10) Pub. No.: US 2026/0050258 A1
(43) Pub. Date: Feb. 19, 2026

(54) INDUSTRIAL MAINTENANCE PLANNING AND TRACKING WITH ROBOTS

(71) Applicant: Rockwell Automation Technologies, Inc., Mayfield Heights, OH (US)

(72) Inventors: Liudmila Domakhina, Toronto (CA); Mohammad Esmalifalak, Toronto (CA); Stuart Fergusson, Toronto (CA)

(21) Appl. No.: 18/807,442

(22) Filed: Aug. 16, 2024

(51) Int. Cl. G05B 23/02; G05B 19/418

(52) U.S. Cl. CPC G05B 23/0283; G05B 19/4184

(57) ABSTRACT

A work order management system automates the process of scheduling maintenance tasks and generating corresponding work orders via analysis of monitored data generated by the industrial assets. The work order management system can monitor status and operational data from industrial devices on the plant floor, as well as mobile industrial robots that traverse the plant floor, and initiate creation of work orders based on a determination that the monitored industrial data indicates a current or predicted performance risk requiring investigation or maintenance. The system can leverage generative artificial intelligence (AI) or other types of AI in connection with determining when and how to schedule a maintenance task intended to mitigate asset risk.

### BACKGROUND

The subject matter disclosed herein relates generally to industrial maintenance, and, more specifically, to industrial work order tracking and planning.

### BRIEF DESCRIPTION

The following presents a simplified summary in order to provide a basic understanding of some aspects described herein. This summary is not an extensive overview nor is it intended to identify key/critical elements or to delineate the scope of the various aspects described herein. Its sole purpose is to present some concepts in a simplified form as a prelude to the more detailed description that is presented later.

In one or more embodiments, a system is provided, comprising a device interface component configured to receive industrial asset data collected by a mobile industrial robot within an industrial facility, wherein the industrial asset data comprises operational and status information for the industrial assets; an analysis component configured to, in response to a determination, based on analysis of the industrial asset data, that a subset of the industrial asset data satisfies a condition indicative of a current or predicted risk to an industrial asset of the industrial assets, formulate one or more maintenance tasks predicted to mitigate the current or predicted risk; and a work order generation component configured to, in response to the determination by the analysis component that the subset of the industrial data satisfies the condition, generate a work order prescribing the one or more maintenance tasks.

Also, one or more embodiments provide a method, comprising receiving, by a system comprising a processor, industrial asset data collected by a mobile industrial robot within an industrial facility, wherein the industrial asset data comprises operational and status information for the industrial assets; and in response to determining, based on analysis of the industrial asset data, that a subset of the industrial asset data satisfies a condition indicative of a current or predicted risk to an industrial asset of the industrial assets: determining, by the system, one or more maintenance tasks predicted to mitigate the current or predicted risk; and generating a work order prescribing the one or more maintenance tasks.

Also, according to one or more embodiments, a non-transitory computer-readable medium is provided having stored thereon instructions that, in response to execution, cause a work order management system to perform operations, the operations comprising receiving industrial asset data collected by a mobile industrial robot within an industrial facility, wherein the industrial asset data comprises operational and status information for the industrial assets; and in response to determining, based on analysis of the industrial asset data, that a subset of the industrial asset data satisfies a condition indicative of a current or predicted risk to an industrial asset of the industrial assets: formulating one or more maintenance tasks predicted to mitigate the current or predicted risk; and generating a work order prescribing the one or more maintenance tasks.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a block diagram of an example industrial control environment.

FIG. 2 is a block diagram of a work order management system.

FIG. 3 a diagram illustrating generation of work orders using the work order management system.

FIG. 4 is a diagram illustrating an example architecture for automatically generating work orders based on analysis of real-time or historical industrial asset performance.

FIG. 5 is a diagram illustrating collection of asset data by an industrial robot and provision of this data to the work order management system.

FIG. 6 is an example work order display that can be rendered on a client device by the user interface component.

FIG. 7 is another example view of the work order display that renders the individual maintenance tasks defined by a work order as a formatted list.

FIG. 8 is a diagram illustrating training of models used by some embodiments of the work order management system.

FIG. 9 is a diagram illustrating interactions between the work order management system and a mobile industrial robot in a scenario in which the robot is used to assist in the performance of maintenance tasks.

FIG. 10 is a flowchart an example methodology for generating work orders in response to a detected risk to an industrial asset.

FIG. 11 is a flowchart an example methodology using trained models to detect actionable risk conditions in industrial assets and to generate work orders to address these risk conditions.

FIG. 12 is an example computing environment.

FIG. 13 is an example networking environment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

Industrial controllers, their associated I/O devices, motor drives, and other such industrial devices are central to the operation of modern automation systems. Industrial controllers interact with field devices on the plant floor to control automated processes relating to such objectives as product manufacture, material handling, batch processing, supervisory control, and other such applications. Industrial controllers store and execute user-defined control programs to effect decision-making in connection with the controlled process. Such programs can include, but are not limited to, ladder logic, sequential function charts, function block diagrams, structured text, or other such platforms.

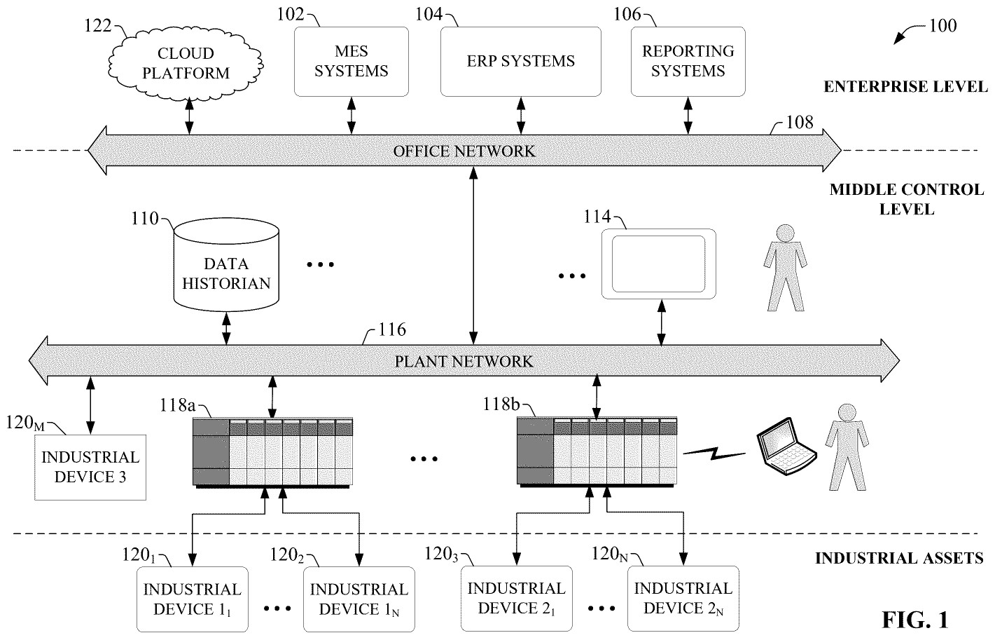

FIG. 1 is a block diagram of an example industrial control environment 100. In this example, a number of industrial controllers 118 are deployed throughout an industrial plant environment to monitor and control respective industrial systems or processes relating to product manufacture, machining, motion control, batch processing, material handling, or other such industrial functions. Industrial controllers 118 typically execute respective control programs to facilitate monitoring and control of industrial devices 120 making up the controlled industrial assets or systems (e.g., industrial machines). One or more industrial controllers 118 may also comprise a soft controller executed on a personal computer or other hardware platform, or on a cloud platform. Some hybrid devices may also combine controller functionality with other functions (e.g., visualization). The control programs executed by industrial controllers 118 can comprise any conceivable type of code used to process input signals read from the industrial devices 120 and to control output signals generated by the industrial controllers, including but not limited to ladder logic, sequential function charts, function block diagrams, or structured text.

Industrial devices 120 may include both input devices that provide data relating to the controlled industrial systems to the industrial controllers 118, and output devices that respond to control signals generated by the industrial controllers 118 to control aspects of the industrial systems. Example input devices can include telemetry devices (e.g., temperature sensors, flow meters, level sensors, pressure sensors, etc.), manual operator control devices (e.g., push buttons, selector switches, etc.), safety monitoring devices (e.g., safety mats, safety pull cords, light curtains, etc.), and other such devices. Output devices may include motor drives, pneumatic actuators, signaling devices, robot control inputs, valves, and the like. Some industrial devices, such as industrial device 120M, may operate autonomously on the plant network 116 without being controlled by an industrial controller 118.

Industrial controllers 118 may communicatively interface with industrial devices 120 over hardwired or networked connections. For example, industrial controllers 118 can be equipped with native hardwired inputs and outputs that communicate with the industrial devices 120 to effect control of the devices. The native controller I/O can include digital I/O that transmits and receives discrete voltage signals to and from the field devices, or analog I/O that transmits and receives analog voltage or current signals to and from the devices. The controller I/O can communicate with a controller's processor over a backplane such that the digital and analog signals can be read into and controlled by the control programs. Industrial controllers 118 can also communicate with industrial devices 120 over the plant network 116 using, for example, a communication module or an integrated networking port. Exemplary networks can include the Internet, intranets, Ethernet, DeviceNet, ControlNet, Data Highway and Data Highway Plus (DH/DH+), Remote I/O, Fieldbus, Modbus, Profibus, wireless networks, serial protocols, and the like. The industrial controllers 118 can also store persisted data values that can be referenced by the control program and used for control decisions, including but not limited to measured or calculated values representing operational states of a controlled machine or process (e.g., tank levels, positions, alarms, etc.) or captured time series data that is collected during operation of the automation system (e.g., status information for multiple points in time, diagnostic occurrences, etc.). Similarly, some intelligent devices—including but not limited to motor drives, instruments, or condition monitoring modules—may store data values that are used for control and/or to visualize states of operation. Such devices may also capture time-series data or events on a log for later retrieval and viewing.

Industrial automation systems often include one or more human-machine interfaces (HMIs) 114 that allow plant personnel to view telemetry and status data associated with the automation systems, and to control some aspects of system operation. HMIs 114 may communicate with one or more of the industrial controllers 118 over a plant network 116, and exchange data with the industrial controllers to facilitate visualization of information relating to the controlled industrial processes on one or more pre-developed operator interface screens. HMIs 114 can also be configured to allow operators to submit data to specified data tags or memory addresses of the industrial controllers 118, thereby providing a means for operators to issue commands to the controlled systems (e.g., cycle start commands, device actuation commands, etc.), to modify setpoint values, etc. HMIs 114 can generate one or more display screens through which the operator interacts with the industrial controllers 118, and thereby with the controlled processes and/or systems. Example display screens can visualize present states of industrial systems or their associated devices using graphical representations of the processes that display metered or calculated values, employ color or position animations based on state, render alarm notifications, or employ other such techniques for presenting relevant data to the operator. Data presented in this manner is read from industrial controllers 118 by HMIs 114 and presented on one or more of the display screens according to display formats chosen by the HMI developer. HMIs may comprise fixed location or mobile devices with either user-installed or pre-installed operating systems, and either user-installed or pre-installed graphical application software.

Some industrial environments may also include other systems or devices relating to specific aspects of the controlled industrial systems. These may include, for example, one or more data historians 110 that aggregate and store production information collected from the industrial controllers 118 and other industrial devices.

Industrial devices 120, industrial controllers 118, HMIs 114, associated controlled industrial assets, and other plant-floor systems such as data historians 110, vision systems, and other such systems operate on the operational technology (OT) level of the industrial environment. Higher level analytic and reporting systems may operate at the higher enterprise level of the industrial environment in the information technology (IT) domain; e.g., on an office network 108 or on a cloud platform 122. These higher level systems can include, for example, enterprise resource planning (ERP) systems 104 that integrate and collectively manage high-level business operations, such as finance, sales, order management, marketing, human resources, or other such business functions. Manufacturing Execution Systems (MES) 102 can monitor and manage control operations on the control level in view of higher-level business considerations, driving those control-level operations toward outcomes that satisfy defined business goals (e.g., order fulfillment, resource tracking and management, asset utilization tracking, etc.). Reporting systems 106 can collect operational data from industrial devices on the plant floor and generate daily or shift reports that summarize operational statistics of the controlled industrial assets

Industrial facilities typically house and operate many industrial assets, machines, or equipment. Many of these assets require regular proactive maintenance to ensure continued optimal operation, in addition to unplanned repair operations to address unexpected downtime events, such as machine malfunctions. To manage the large number of maintenance operations carried out at a given industrial enterprise, work order management systems can be used to initiate work orders for new maintenance operations to be performed, to track the statuses of these work orders, and to keep a record of maintenance operations performed within the plant. In a typical scenario for addressing a reactive maintenance concern, when metered or observed asset performance indicators—e.g., vibration values, temperature values, product counts, a machine downtime occurrence, etc.-indicate a possible performance concern requiring investigation or maintenance, a maintenance technician or manager creates and submits a work order for the maintenance operation to the work order management system. Maintenance personnel are then assigned the task of performing the maintenance task or investigation. As the work is carried out, maintenance actions performed in connection with the schedule maintenance task are submitted and recorded with the work order, which remains open as its corresponding maintenance task is performed. The work order is then closed once the task is completed. A similar workflow can be used to schedule regular proactive or preventative maintenance on industrial assets.

This approach to maintenance management requires operators, maintenance staff, or supervisors to visually observe when machine performance indicators, or predetermined asset maintenance schedules, necessitate scheduling of a maintenance action and creation of a corresponding work order for the maintenance task. If a performance concern is observed or a preventative maintenance task to be scheduled, the work order must be created by a maintenance supervisor or technician so that the maintenance work is properly logged and tracked. The process of manually creating and submitting work orders is susceptible to errors due to improperly entered work order information. Errors in the work order submission process are common, and these errors may have associated risks that directly affect the underlying industrial assets on which maintenance is performed, or that adversely affect future decisions made by the industrial enterprise.

To address these and other issues, one or more embodiments described herein provide a work order management system that automates the process of scheduling maintenance tasks and generating corresponding work orders via analysis of monitored data generated by the industrial assets. In one or more embodiments, the work order management system can monitor control, status, and/or operational data from industrial devices on the plant floor, and initiate creation of work orders based on a determination that the monitored industrial data indicates a current or predicted performance risk requiring investigation or maintenance. In some embodiments, the work order management system can leverage generative artificial intelligence (AI) or other types of AI in connection with determining when and how to schedule a maintenance task intended to mitigate asset risk. To assist in both automated detection of industrial asset risks requiring maintenance actions as well as the execution of those maintenance actions, some embodiments of the work order management system can interface with one or more mobile robots at a plant facility. These robots can provide the work order management system with asset identification and troubleshooting information, which is used by the system to identify asset risks conditions and to schedule maintenance tasks for mitigating these risks. The system can also instruct the robots to perform tasks that assist technicians in completing the maintenance workflow. These robot-assisted tasks can include, but are not limited to, part or tool retrieval, inventory tracking, or direct performance of maintenance tasks.

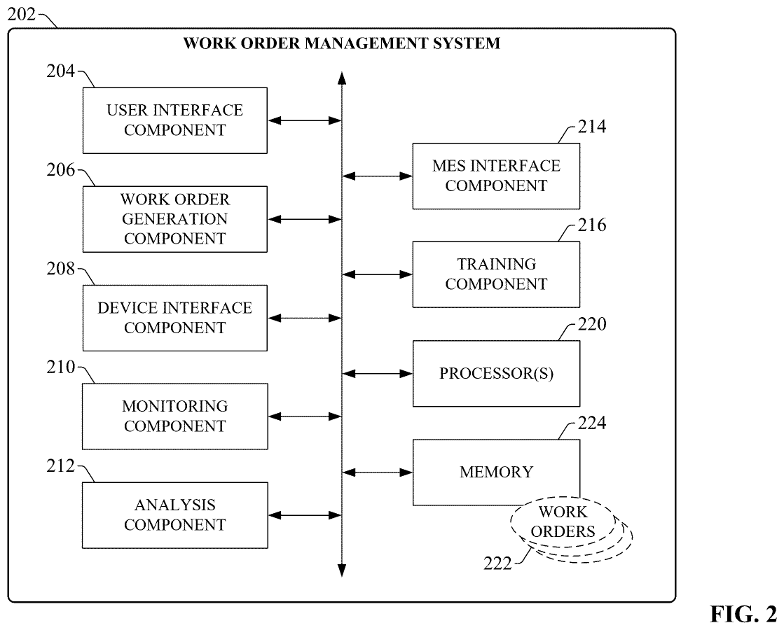

FIG. 2 is a block diagram of a work order management system 202 according to one or more embodiments of this disclosure. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

Work order management system 202 can include a user interface component 204, a work order generation component 206, a device interface component 208, a monitoring component 210, an analysis component 212, an MES interface component 214, a training component 216 one or more processors 220, and memory 224. In various embodiments, one or more of the user interface component 204, work order generation component 206, device interface component 208, monitoring component 210, analysis component 212, MES interface component 214, training component 216, the one or more processors 220, and memory 224 can be electrically and/or communicatively coupled to one another to perform one or more of the functions of the work order management system 202. In some embodiments, components 204, 206, 208, 210, 212, 214, and 216 can comprise software instructions stored on memory 224 and executed by processor(s) 218. Work order management system 202 may also interact with other hardware and/or software components not depicted in FIG. 2. For example, processor(s) 220 may interact with one or more external user interface devices, such as a keyboard, a mouse, a display monitor, a touchscreen, or other such interface devices.

User interface component 204 can be configured to generate user interface displays that receive user input and render output to the user in any suitable format (e.g., visual, audio, tactile, etc.). In some embodiments, user interface component 204 can render these interface displays on a client device (e.g., a laptop computer, tablet computer, smart phone, etc.) that is communicatively connected to the work order management system 202 (e.g., via a hardwired or wireless connection). Input data that can be received via user interface component 204 can include, but is not limited to, work order data (e.g., work order data field entries), user interface navigation input, or other such input data. Output data rendered by user interface component 204 can include, but is not limited to, information regarding closed and open work orders, maintenance planning recommendations or guidance, recommended workflows for performing a maintenance task defined by a work order, results of maintenance tracking analysis, optimized maintenance routes, or other such output data.

Work order generation component 206 can be configured to generate work orders 222 based on user-submitted information about a maintenance task to be performed, or based on detected or predicted asset risks. In some embodiments, the work order generation component 206 can generate work orders and schedule corresponding maintenance tasks based on analysis performed by the analysis component 212, which can also be assisted using generative AI.

Device interface component 208 can be configured to interface with industrial devices or assets on the plant floor, either directly or via a gateway or edge device, and receive real-time operational and status data from these assets for the purposes of asset health monitoring and analysis. Device interface component 208 can also receive data from mobile industrial robots that traverse the plant floor and collect Monitoring component 210 can be configured to monitor specified sets of the collected industrial data or robot-collected data for conditions indicative of a performance issue requiring investigation or maintenance. In some embodiments, the sets of industrial data to be monitored, as well as the conditions of this data that indicate a performance concern that requires a maintenance task to be scheduled, can be defined by machine-specific asset models for the industrial equipment being monitored, can be determined or defined by the system 202 based on analysis of the assets' performance over time, or can be manually configured by an administrator of the system 202. The monitoring component 210 can also monitor certain human behaviors, such as those performed by maintenance personnel in connection with performing maintenance tasks associated with respective work orders 222.

Analysis component 212 can be configured to perform analysis on real-time or historical asset performance data, robot-collected data, data obtained from an MES system or a similar high-level enterprise tracking system, contextual information, or other such data to determine when maintenance tasks are to be scheduled, what those maintenance tasks include, and which technicians are to be assigned the tasks. In some embodiments, the analysis component 212 can apply AI or generative AI-assisted analysis to this data in connection with determining when and how maintenance tasks should be scheduled and corresponding work orders generated. Analysis component 212 can also formulate substantially optimized workflows, maintenance schedules, or technician assignments for performing maintenance activities on open work orders 222.

MES interface component 214 can be configured to retrieve, from an MES system or another source of industrial enterprise data, information that can be used by the analysis component 212 to determine when maintenance tasks should be scheduled, which technicians should be assigned the tasks, the nature of the maintenance tasks that should be performed to mitigate a detected risk, optimized workflows or routes for carrying out a scheduled maintenance task, or other such determinations. In some embodiments, the MES interface component 214 can also initiate transmission of notifications to appropriate personnel via the MES in conjunction with generation of work orders 222. Training component 216 can be configured to train one or more trained models with various types of relevant training data. These trained models are used by the system 202 in connection with identifying asset risk conditions that require scheduling of a maintenance action, generating maintenance and performance statistics and insights for customers' industrial assets, and other such functions.

The one or more processors 220 can perform one or more of the functions described herein with reference to the systems and/or methods disclosed. Memory 224 can be a computer-readable storage medium that stores computer-executable instructions and/or information for performing the functions described herein with reference to the systems and/or methods disclosed. Memory 224 can also store the work order data submitted by users as work orders 222.

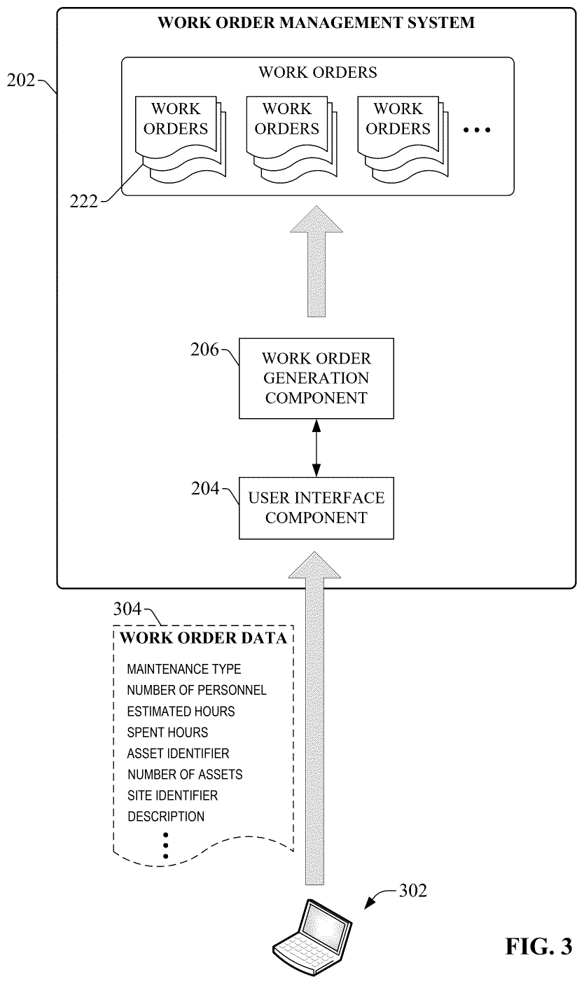

FIG. 3 is a diagram illustrating generation of work orders 222 using the work order management system 202. Work order management system 202 can be implemented on any suitable platform that allows the system 202 to be accessed via client devices 308 (e.g., desktop computers, laptop computers, smart phones, tablet computers, wearable computing devices, etc.). For example, system 202 can be executed on a cloud platform as a set of cloud-based services, allowing multiple customer entities across multiple industrial facilities to access the system 202 and initiate work orders 222, view work orders 222, or view work order analysis results. System 202 can also be executed on a public network such as the internet and made accessible to users having suitable authorization credentials. In such embodiments, the system 202 can maintain work orders 222 for different industrial enterprises in a segregated manner, such that employees of a given industrial enterprise can only access work orders and associated analysis results associated with that enterprise.

The user interface component 204 can allow client devices 302 to communicatively interface with the work order management system 202 and submit work order data 304. This work order data 304 can represent either a newly initiated work order for a maintenance task to be performed, or updated information for an open work order 222 that was previously submitted to the system 202. Substantially any work order format can be supported by various embodiments of work order management system 202. In an example scenario, user interface component 204 can generate and deliver, to the client device 302, user interface displays comprising editable data fields representing features of the maintenance job represented by the work order 222. Items of work order data 304 that can be submitted to the system 202 in this manner can include, but are not limited to, a type of maintenance to be performed, a description of the maintenance, the number of personnel required to perform the maintenance, an estimated number of hours to perform the maintenance, an actual number of hours spent on the job, identities and numbers of industrial assets that are subject to the maintenance, identities of industrial sites or facilities in which the maintenance takes place, materials to be used to perform the job, an expected cost to perform the job (e.g., costs of replacement parts), or other such information. Embodiments of the work order management system 202 are not

limited to submission of work order data 304 via such user interfaces. For example, in some embodiments the system 202 can allow the user to submit work order data 304 as natural language text or speech via a chat interface rendered by the system 202. In such embodiments, the work order generation component 206 can translate this natural language input to corresponding work order data 304 which is then used to populate the content of the relevant work order 222.

Based on submitted work order data 304 describing a reactive or proactive maintenance task to be performed, work order generation component 206 can generate a work order 222 containing information about the maintenance task (or set of tasks) to be performed. The system 202 can classify each work order 222 as either an open work order representing a pending maintenance job to be performed on one or more industrial assets (e.g., machines, production lines, industrial devices, etc.) or a closed work order representing a maintenance job that has been completed.

Creation of work orders 222 via manual submission of work order data 304 by plant personnel, as illustrated in FIG. 3, can be suitable for initiating work orders 222 for reactive maintenance tasks, in which the maintenance tasks are intended to address an unexpected asset performance problem or risk condition. Additionally or alternatively, some embodiments of the work order management system 202 can generate some types of work orders 222 automatically according to a defined maintenance schedule. For example, the work order generation component 206 can be configured to automatically generate and schedule work orders 222 for proactive or scheduled maintenance tasks designed to prolong an industrial asset's lifecycle or to proactively prevent asset failures or performance inefficiencies. These proactive maintenance actions can include, for example, oil changes, inspection routines, proactive replacement of parts at regular intervals, or other such scheduled maintenance tasks. The system 202 can generate and schedule these proactive work orders 222 at regular or semi-regular intervals according to a defined frequency at which the maintenance is to be conducted.

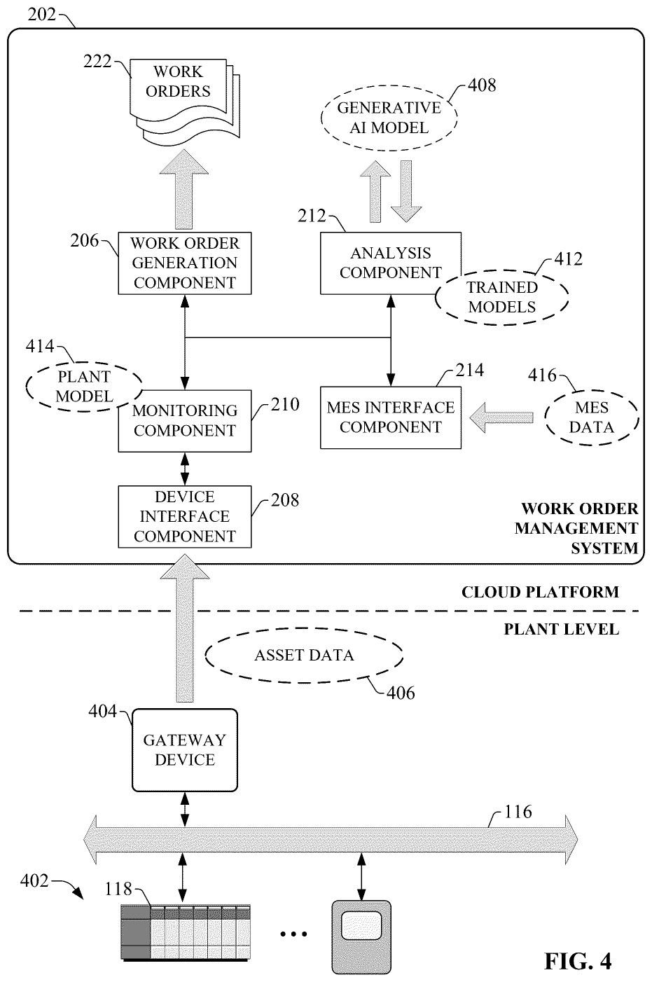

Also, some embodiments of the system 202 can automatically generate reactive work orders 222 in response to real-time detection of an asset performance issue. FIG. 4 is a diagram illustrating an example architecture for automatically generating work orders 222 based on analysis of real-time or historical industrial asset performance. In the example architecture of FIG. 4, a gateway device 404 resides on the same plant network 116 as the industrial devices 402 associated with automation systems on the plant floor. These industrial devices 402 can include, for example, industrial controllers 118, motor drives, HMI terminals, telemetry devices (e.g., flow meters, pressure meters, temperature meters, etc.), sensors of various types (e.g., photo-sensors, proximity sensors, etc.), or other such devices. The automation systems and their associated industrial devices 402, machines, and machine components constitute industrial assets for which reactive or proactive maintenance may be scheduled as needed. During operation of the plant's automation systems, gateway device 404 collects asset data 406 from industrial devices 402. This data can include data values read from data tags, data registers, or automation objects defined on one or more industrial controllers 118; data from analog or digital sensors; data from telemetry devices or meters, or other such data. In general, asset data 406 represents status, operational, or performance data for the industrial assets.

In some embodiments, gateway device 404 can contextualize the collected data 406 prior to delivering the data to the work order management system 202 and deliver the processed data to the system 202 as contextualized data. This contextualization can include time-stamping the data, as well as normalizing or otherwise formatting the collected data for analysis by the work order management system 202. In general, gateway device 404 serves as an edge device that interfaces data from the set of industrial devices 402 to either the work order management system 202 or a separate data storage platform accessible to the work order management system 202.

Although FIG. 4 depicts a scenario in which the system 202 collects and processes asset data 406 from only a single facility owned by a single customer, the work order management system 202 is scalable across multiple industrial facilities. In this regard, the system 202 can serve as a single platform that provides work order generation, maintenance tracking, and maintenance insight services for multiple industrial customers. To achieve this scalability, the system 202 can maintain segregation of respective customer's proprietary data, and can also execute separate instances of the system's services and models 412 for the respective customers.

The work order management system's device interface component 208 can remotely interface with the gateway device 404 to receive the collected asset data 406, and the system's monitoring component 210 can monitor the asset data 406 for conditions indicative of a possible performance issue that necessitates a maintenance action and creation of a corresponding work order 222. In some embodiments, rather than obtaining asset data 406 from the industrial assets (e.g., industrial devices 402 and their associated machines or automation systems) via an integrated device interface component 208, the system's monitoring component 210 may access other sources of real-time or historical asset data 406 generated by the industrial assets within the plant facility, such as a data historian system, a data lake, or other such systems.

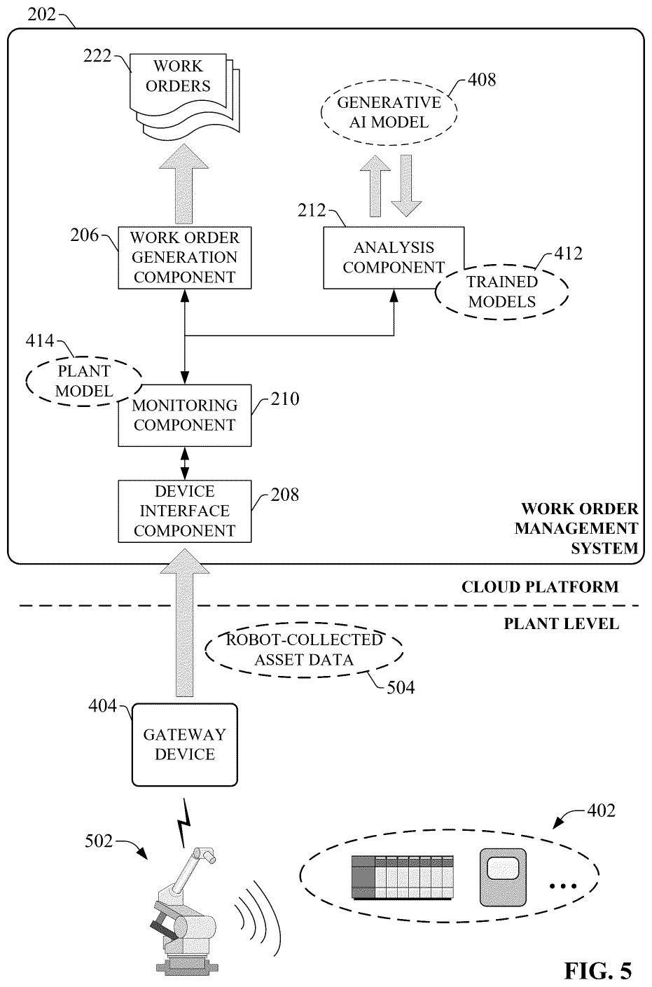

Some embodiments of the work order management system 202 can also interface with, and receive asset data 406 from, mobile robots that traverse the plant facility. FIG. 5 is a diagram illustrating collection of asset data 504 by an industrial robot 502 and provision of this data 504 to the work order management system 202. Embodiments of the work order management system 202 can interface with substantially any type of industrial robot 502 for the purposes of robot-assisted data collection. Such robots 502 can include, for example, material handling or transportation robots configured to transport parts or materials between locations within the plant. Robots 502 may also include mobile inspection robots configured to traverse an industrial facility and collect various types of information from the facility's industrial assets. These inspection robots 502 can be equipped with sensors of one or more types which are used by the robot 502 to collect operational or status data from the industrial assets. These sensors can include, but are not limited to, infrared sensors, optical sensors such as time-of-flight sensors, two-dimensional or three-dimensional cameras, near-field or wireless communication interfaces configured to read telemetry data stored on the industrial devices 402, or other such data collection equipment. Some robots 502 may be equipped with manipulation or tooling mechanisms, such as robotic arms with gripping mechanisms or tooling attachments, and are programed to perform material handling or tooling tasks. Other types of robots 502 are also within the scope of one or more embodiments of this disclosure.

The work order management system's device interface component 208 can receive robot-collected asset data 504 from one or more robots 502 at the plant facility via any suitable communication architecture. For example, in some architectures the robot 502 may interface with the plant network and send its collected asset data 504 to the work order management system 202 via the gateway device 404. However, other communication architectures or data routes through which the robot 502 provides its collected asset data 504 to the system 202 are also within the scope of one or more embodiments. The work order management system 202 can use the robot-collected asset data 406 in a manner similar to asset data 406 to identify asset performance issues and generate corresponding work orders 222 to address these issues.

For example, inspection robots 502 can traverse inspection routes within the plant facility and measure the states of specific industrial assets or machines; e.g., by performing infrared panel scans, reading data from meters or from the industrial devices 402 themselves, by capturing two-dimensional or three-dimensional image data of the assets, or performing other such information scans. The robot 502 can then feed this collected information to the work order management system 202 as robot-collected asset data 504. Substantially any type of information relating to operational conditions, statuses, or health of industrial assets can be collected by the robots 502 and provided to the system 202 as robot-collected asset data 504. For example, some inspection robots 502 may incorporate vision systems that capture photographic or image data of an industrial asset or machine, or a component thereof, and determine a status of the asset based on analysis of this photographic data (e.g., based on a determination of whether the image data captured for the asset or component deviates from a reference image of the asset or component in a manner indicative of a part defect, an improperly manufactured product, or component wear requiring a replacement of the component). The work order management system's device interface component 208 can collect results of this vision analysis as robot-collected asset data 504, and the analysis component 212 can uses these results in connection with determining whether a maintenance action should be scheduled for the asset and a corresponding work order 222 generated, as described in more detail below.

In another example, an inspection robot 502 can include wireless data scanning systems that allow the robot 502 to wirelessly interface with sources of status or operational data for an asset (e.g., via a near-field communication link or another wireless communication protocol) and read this data from these data sources for provision to the work order management system as asset data 504. This can include, for example, scanning and collecting metered data from meters or telemetry devices (e.g., temperature meters, flow meters, pressure meters, fill levels, etc.), machine status or operational data from data tags of an industrial controller 118, inspection result data from part inspection stations, or asset status data from other such sources.

Some mobile robots 502 can also be equipped with sensors capable of directly measuring status or performance metrics for industrial assets. Such sensors can include, but are not limited to, presence sensors, time-of-flight cameras or other types of three-dimensional sensors, heat sensors, or other such measurement or inspection sensors. Some robots 502 may also be equipped with motion amplification sensor capable of measuring vibrational information or other subtle motion information from industrial assets or asset components for which vibration is a measure of performance or health. Such robots 502 can collect and amplify motion or vibrational information from these assets and components and provide this information to the work order management system 202 as part of robot-collected asset data 504.

In some scenarios, the system 202 can also use mobile robots 502 to identify new industrial assets within the plant facility and to report the identities of these new assets to the system 202 as part of robot-collected asset data 504. In this regard, robots 502 can be used by the work order management system 202 as discovery agents that assist the system 202 in maintaining an up-to-date inventory of the industrial assets that are in use within the customer's facility. When a new industrial asset is reported to the system 202 as part of robot-collected asset data 504, the system 202 can record such information as the type of the industrial asset (e.g., a type of machine or industrial device), a location of the asset (as reported explicitly by the robot 502 or inferred based on the location of the robot 502 at the time the asset was reported), any relevant mechanical or performance characteristics of the asset observed by the robot 502, or other such information. The monitoring component 210 can record this asset information as part of the plant model 414 (if used) or in another database of customer assets maintained by the system 202. Once a newly discovered asset has been registered in this manner, the system 202 will begin monitoring asset data 406, 504 for the asset and scheduling maintenance tasks for the asset as described above.

When the monitoring component 210, assisted by the analysis component 212, determines that the monitored asset data 406 or the robot-collected asset data 504 satisfies a condition indicative of a current or predicted asset performance issue requiring investigation or correction by maintenance personnel, system's work order generation component 206 can schedule one or more maintenance tasks predicted to correct the performance issue and generate a corresponding work order 222 for the tasks. The condition detected by the monitoring component 210 that triggers creation of a work order 222 can be, for example, a deviation of one or more data tag values that move outside a defined range of normal or expected values, or a deviation of a trend of these data tag values from a learned trend indicative of normal or acceptable asset performance. In an example scenario, a baking process may require an oven temperature to stay within a defined temperature range. Accordingly, values of a data tag or automation object corresponding to this oven temperature can be collected from the industrial controller 118 that monitors and controls the baking process, and this collected data can be provided to the work order tracking system 202 as part of the asset data 406 or robot-collected asset data 504. The monitoring component 210 monitors this value to determine when the oven temperature deviates from this range and, in response to detecting such a deviation, instructs work order generation component 206 to generate a new open work order 222 for investigation of the temperature control issue. In some embodiments, machine-specific asset models maintained on the work order tracking system 202 can define which data items or performance parameters of the industrial assets are to be monitored, as well as the conditions of this data that are to trigger creation of work orders 222. In other embodiments, the system 202 can learn to recognize conditions of the asset data indicative of an elevated risk to an asset using machine learning, AI, generative AI, or other analytic techniques.

In some scenarios in which a given machine performance metric is a function of the current states of other performance metrics, the condition that triggers creation of a work order 222 can be based on a holistic set of data value conditions rather than being based on deviation of a single data value. For example, an expected value of a given performance metric for a machine or automation system—e.g., a conveyor speed, an oven temperature, a fill level, etc.—may depend on the current operating mode of the machine, a speed or temperature of another machine component, or other such factors. The value of the performance metric may also be seasonal or time-specific, such that the expected value of the metric depends on a current time of day, a current day of the week, a current month of the year, or another time function. If the health of a machine or automation system is a function of whether concurrent values of multiple data tags are within an expected holistic value space, the monitoring component 210 can be configured to instruct the work order generation component 206 to generate a work order 222 upon determining that these values are in a collective, concurrent state indicating a potential performance problem.

A work order 222 generated by the work order generation component 206 can contain information about the maintenance task to be performed, including but not limited to an identity of the industrial asset or machine for which maintenance is required, an aspect of the industrial asset that requires attention, a type of the maintenance to be performed, an estimated number of hours to be spent on the maintenance task, an estimated number of personnel to be assigned to the task, a description of the task, or other such information. The work order 222 is initially scheduled in the system 202 as an open work order 222 (that is, the system 202 stores the work order 222 as work order data in memory 224 and assigns an “Open” status to the work order 222) and remains open until completion of its associated maintenance tasks, at which time the system 202 assigns a “Closed” status to the work order 222.

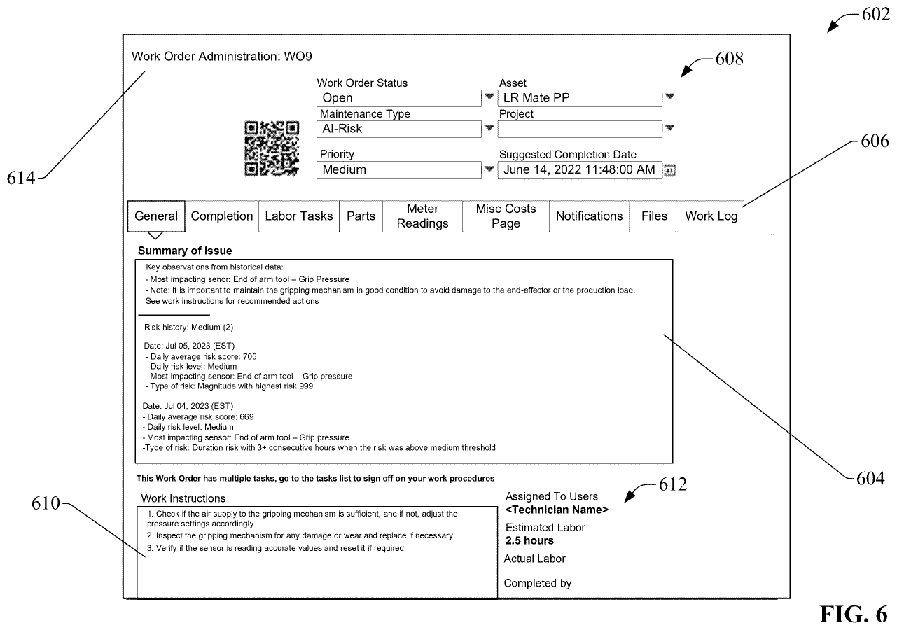

Authorized users can browse and view both open and closed work orders 222 via user interface component 204. FIG. 6 is an example work order display 602 that can be rendered on a client device by the user interface component 204. When a user selects a work order 222 via interaction with the work order system's primary user interface, the user interface component 204 can render a work order display 602 and populate the display 602 with information about the work order. In the example depicted in FIG. 6, the work order display 602 comprises a work order identifier 614 that uniquely identifies the selected work order 222, a section 608 that displays general information about the work order 222 (e.g. the open or closed status, a type of maintenance to be performed, a priority, an identity of the asset on which the maintenance task is to be performed, a suggested completion date for the maintenance, a name of a project with which the maintenance task is associated, etc.), and a navigation bar 606 comprising selectable controls corresponding to respective different categories of additional information that can be viewed.

In the illustrated example, the user has selected the General category from the navigation bar 606, which causes the work order display 602 to render a Summary box 604 containing summary information about the maintenance task, including a description of the asset performance issue or risk to be mitigated by the maintenance task, relevant key observations about the asset, risk information for the asset (e.g., a daily average risk score or a risk level), or other such information. The display 602 also renders an Instructions box 610 that displays instructions for performing the maintenance task, and a section 612 that displays miscellaneous additional information (e.g., identities of the technicians assigned to perform the maintenance task, an estimated number of hours for performing the task, the actual number of hours that were required to perform the tasks, or other such information.

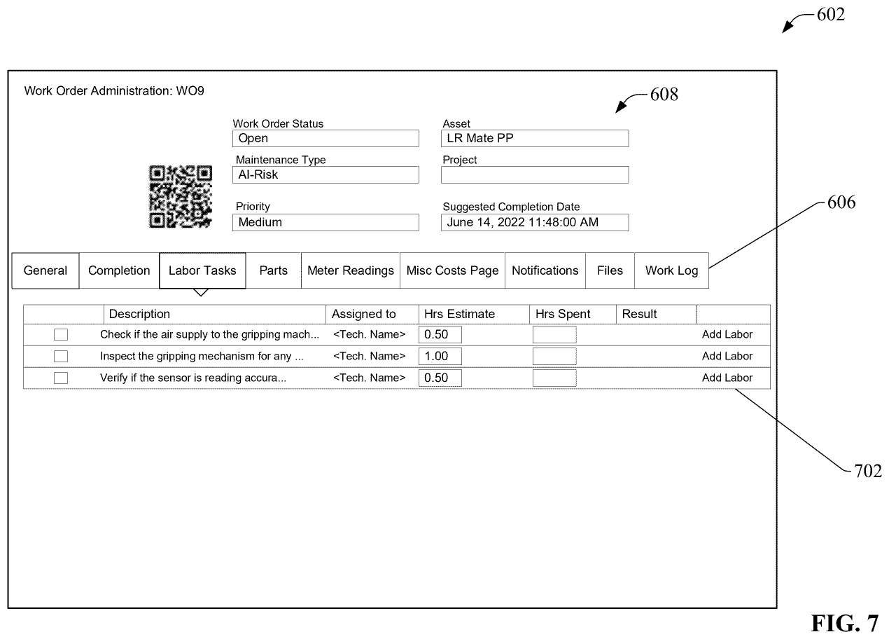

FIG. 7 is another example view of the work order display 602 in which the user has selected the Labor Tasks category from the navigation bar 606, which causes the display 602 to render the individual maintenance tasks defined by the work order 222 as a formatted list 702. Each entry of the list 702 represents a task to be performed, and includes a description of the task, an identity of a maintenance technician to whom the task is assigned, fields for the estimated and actual number of hours spent on the task, a result of the task, and an interactive checkbox control for indicating that the task has been completed.

Some embodiments of the work order tracking system 202 can reference information about the industrial assets in use within a plant facility, and the functional or geographic relationships between these assets, in connection with determining when to schedule maintenance activities or generating maintenance planning and tracking data. In some embodiments, this information can be maintained in a plant model 414 that defines industrial machines, systems, or assets within the plant facility as well as the functional or geographical relationships between those assets. For example, the plant model 414 may define the relative locations of respective machines or automation systems within the plant, functional relationships between the machines (e.g., interdependencies between the machines or systems, such as indications of which automation systems are responsible for providing material or parts to other downstream systems), or other such asset information.

To facilitate intelligent automated generation of work orders 222, the monitoring component 210 can be assisted by an analysis component 212 in some embodiments. The analysis component 212 that can apply one or more types of analysis (e.g., artificial intelligence (AI), generative AI analysis or generative AI-assisted analysis, machine learning, etc.) to real-time or historical asset data 406, robot-collected asset data 504, MES data 416 from the plant facility's MES system or another high-level plant managements system, and other contextual data in connection with determining when to schedule maintenance tasks, what these maintenance tasks entail, and which technicians are to be assigned the tasks. For example, in some embodiments, the analysis component 212 can leverage generative AI to automatically generate work orders 222 or otherwise schedule maintenance tasks based on predicted or detected asset risks. In such embodiments, the analysis component 212 can be configured with prompt engineering functionality using associated trained models 412 trained with various types of training data, and can use these prompt engineering features to interface with a generative AI model 408 (e.g., a large language model (LLM) or another type of model) and associated neural networks.

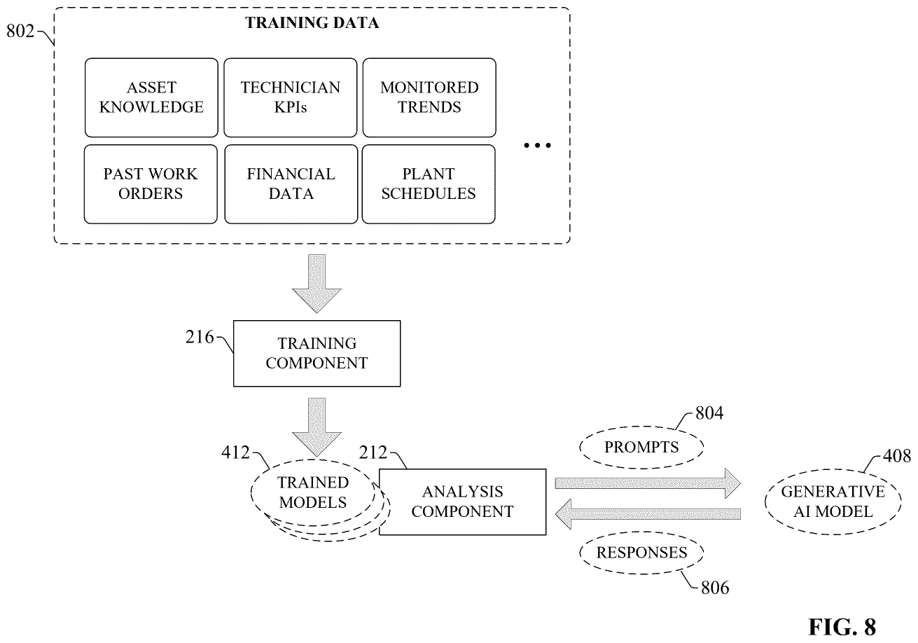

FIG. 8 is a diagram illustrating training of the models 412 used by some embodiments of the analysis component 212. The system's training component 216 can train models 412 using training data 802 relevant to identification or prediction of risks to the plant facility's industrial assets, scheduling of suitable maintenance tasks for mitigating the risks, and assignment of those maintenance tasks to suitable technicians. Such training data 802 can include, but is not limited to, knowledge or technical specifications of industrial assets, machines, and devices that are in service within the industrial facility; information from past or closed work orders 222; monitored trends in asset operation (e.g., histories and frequencies of asset failure); information about technicians employed by the plant facility (e.g., employee identities, skill sets, work histories relative to specific assets or types of maintenance tasks, work schedules etc.); financial data for the plant facility; or other such data 802.

The monitoring component 210 and analysis component 212 can detect a current asset risk condition (or predict a future asset risk condition) that requires scheduling of a maintenance task and generation of a corresponding work order 222 based on analysis of real-time or historical asset data 406 and robot-collected asset data 504, as well as content of the trained models 412. In some scenarios, this analysis can be performed without accessing the generative AI model 408. However, the analysis component 212 can also, as needed, interact with the generative AI model 408 as part of the risk detection analysis, or as part of the work order generation process. For example, as the work order management system 202 is monitoring asset data 406 and/or robot-collected asset data 504 for risk conditions, the analysis component 212 can determine whether a given subset of the asset data 406 generated by an industrial asset or related groups of assets (or asset data 504 collected for the asset by an industrial robot 502) is indicative of a risk condition based on knowledge of the relevant industrial assets (e.g., values of performance indicators known or inferred to correlate with a risk condition for those specific assets, the nature of the risk condition indicated by anomalous values of those performance indicators, lifecycle information for the assets, etc.), and this asset knowledge can be obtained from technical asset information encoded in the trained models 412 as part of training data 802 or can be prompted from the generative AI model 408 using suitable prompts 804 generated by the analysis component 212.

Similarly, when an asset risk is detected, the analysis component 212 can determine a suitable set of maintenance tasks for mitigating the detected or predicted risk based on the training data 802 encoded in the models 412, as well as responses 806 prompted from the generative AI model 408. Responses 806 prompted from the generative AI model 408 can also be used by the work order generation component 206 to generate natural language content to be included in the corresponding work order 222 (e.g., natural language descriptions of the asset risk, natural language descriptions of the maintenance tasks rendered, etc.).

In the scenarios described above, the analysis component 212 may prompt the generative AI model 408 for supplemental information in response to determining that additional information from the generative AI model 408 would yield an analytic result having a higher probable level of accuracy relative to relying solely on the asset data 406, 504 and trained models 412 alone. To support generative AI-assisted generation and scheduling of work orders 222, the analysis component 212 can be configured with custom prompt engineering capabilities designed to prompt the generative AI model 408 for supplemental information that can be used by the work order management system 202 to recognize industrial asset risk conditions, infer suitable corrective maintenance tasks for mitigating asset-specific risks, and generate content of a work order 222 for the maintenance tasks.

During the asset monitoring process, the analysis component 212 can formulate and submits prompts 804 to the generative AI model 408 designed to obtain responses 806 that can assist with monitoring the performance of industrial assets for risk conditions, formulating maintenance strategies for mitigating the risk conditions, or generating content of a work order 222. The analysis component 212 can generate these prompts 804 based on a current operating context of one or more industrial assets being monitored (as determined from real-time or historical asset data 406, 504) as well as the training data 802 encoded in the trained models 412. The analysis component 212 can reference the trained models 412 or associated training data 802 as needed in connection with creating prompts 804 designed to obtain responses 806 from the generative AI model 408 that assist the analysis component 212 in recognizing a current or predicted risk to an industrial asset, formulating a maintenance intervention for mitigating the risk, or generating content of a work order 222 for scheduling the maintenance intervention (e.g., natural language summaries of the identified asset risk, as well as descriptions of the maintenance tasks for mitigating the risk). The analysis component 212 can generate the prompt 804 to include any relevant information that can assist the generative AI model 408 in converging on a useful responses 806 that can be used to better understand a current context of the industrial assets, including but not limited to a selected subset of the asset data 406, 504 itself, the type of industrial asset of interest (e.g., a type of machine or industrial device), an indication of the type of industrial process or application being carried out by the industrial asset of interest (e.g., a specific type of batch processing, a specific automotive manufacturing function, a sheet metal stamping application, etc.), any selected subsets of the training data 802 or MES data 416, or other such data.

The techniques described above for generating or initiating a work order 222 within the work order management system 202 are only intended to be exemplary, and it is to be appreciated that substantially any technique for initiating a work order 222 using work order management system 202 are within the scope of one or more embodiments of this disclosure.

In some embodiments, the trained models 412 can include one or more predictive models that are trained by the training component 216 to forecast or predict future performance issues or failure risks for the industrial assets. The training component 216 can automatically train these predictive models using machine learning algorithms applied to asset data 406, 504 collected from the assets over time, from which the predictive models can learn performance trends for individual industrial assets and use these trends to predict future performance issues. The work order management system 202 can use these predictive models to identify potential future asset failures or performance degradations, and to automatically generate work orders 222 for maintenance activities designed to mitigate these issues in response to these predictions.

Since the work order management system 202 is a multi-tenant system that provides work order tracking, maintenance planning, and asset performance insights for multiple industrial customers having respective different collections of industrial assets and maintenance practices, the system 202 can maintain, train, and execute respective customer-specific predictive models for these different customers. Initially, when a customer begins using the system's maintenance planning and tracking services, the customer's initial predictive model can be pre-trained using a range of relevant domain-specific data that is not necessarily specific to the customer's asset operation and maintenance activities, such as knowledge or technical specifications of various industrial assets, machines, and devices; knowledge of various types of industrial verticals (e.g., automotive, mining, food and drug, pharmaceuticals, etc.); knowledge of various types of industrial applications; or other such training data 502. This initial training yields a predictive model that can be used by the analysis component 212 to generate predictive insights (in the form of predicted maintenance statistics) regarding the performance the customer's specific assets, to predict potential asset failures or performance degradations, and to generate work orders 222 and formulate optimized maintenance schedules based on these predictions. The system 202 is capable of generating these predictive insights and performing predictive maintenance scheduling automatically.

Over time, as customer-specific asset data 406, 504 is collected by the system 202, the training component 216 can apply machine learning to retrain the customer-specific predictive model using this collected asset data 406. The system 202 can perform this retraining of the predictive model automatically based on actual monitored performance of the customer's industrial assets over time, as well as information obtained from work orders 222 that have been opened and executed for the respective assets. In this way, each customer's predictive model can learn trends in performance of the customer's various industrial assets, histories and frequencies of failures for the various assets, and other such customer-specific performance histories. The analysis component 212 can then use this re-trained predictive model to improve the accuracy of the predictive maintenance statistics delivered to the customer and to improve the effectiveness and efficiency of maintenance schedules generated by the system 202. The training component 416 can automatically perform retraining of a customer's predictive model according to a periodic retraining schedule (e.g., by applying machine learning to an updated data set comprising any new asset data 406, 504 that has been received since previous retraining) or in response to a defined retraining condition.

The system 202 can scale these predictive insight services across any number of industrial customers, training and re-training each customer's proprietary predictive model automatically over time by applying machine learning to the customer's proprietary asset data 406, 504.

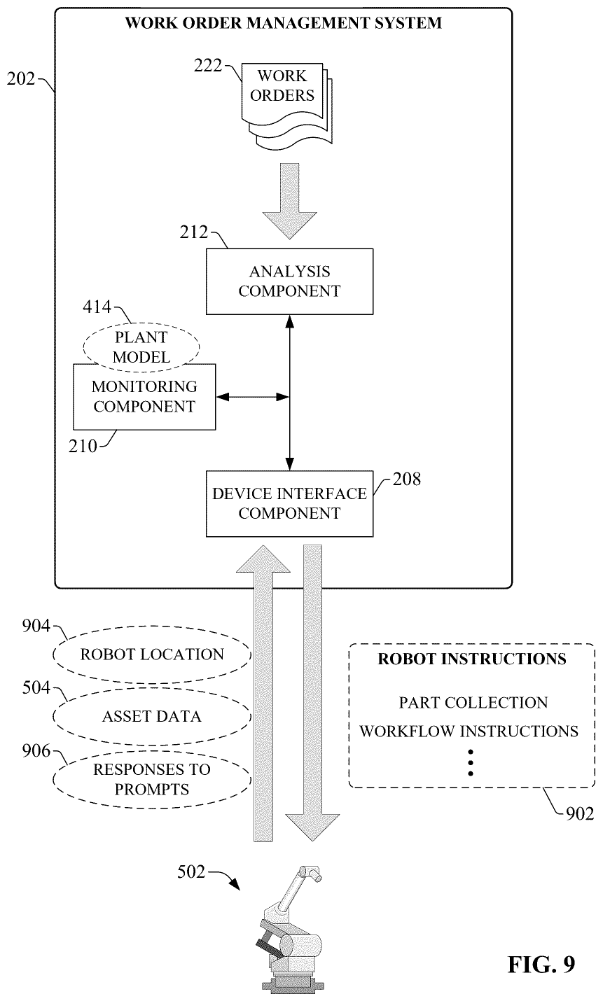

In addition to using mobile industrial robots 502 to collect and provide asset data 504 to the work order management system 202 as described above, some embodiments of the system 202 can also instruct and coordinate mobile robots 502 to assist with execution of work orders 222. FIG. 9 is a diagram illustrating interactions between the work order management system 202 and a mobile industrial robot 502 in a scenario in which the robot 502 is used to assist in the performance of maintenance tasks. As a technician is engaged in performing a maintenance task associated with a work order 222 to which the technician has been assigned, the analysis component 212 can determine, based on the maintenance tasks defined by the work order 222, subsets of the maintenance tasks that can be carried out by the robot 502 without the need for human intervention or assistance, or secondary tasks that the robot 502 can perform that will assist the technician in performing one or more of the maintenance tasks. Based on these assessments, the analysis component 212 can generate robot instructions 902 that program or otherwise instruct the robot 502 to perform the tasks or assistance activities, and send these instructions to the robot 502 via the device interface component 208.

For example, if one of the defined maintenance tasks requires the use of a tool or a component part that is not present at the maintenance site, the robot instructions 902 may instruct the robot 502 to collect and bring the necessary tool or part to the maintenance location. In some scenarios, the analysis component 212 can access a source of information specifying the storage locations of tools and parts within the plant facility (e.g., the plant model 414 or another source of such information) and provide this information as part of the instructions 902. Alternatively, the robot 502 may be provisioned with local preprogrammed knowledge of the location of various tools and parts within the facility. In such scenarios, the robot instructions 902 may omit tool or component location information and only identify the type of tool or component required and the identity of the maintenance site to which the tool or part should be delivered.

In the case of instructing robots 502 to perform maintenance tasks autonomously, the analysis component 212 can identify a subset of the work order's defined maintenance tasks that can be performed by one or more robots 502 and translate these tasks to maintenance workflow instructions 902 for delivery to the robots 502. These tasks can include, but are not limited to, performing a tooling action on a machine or component, operating panel controls, relocating or removing units of product manufactured by the machine on which maintenance is being performed, performing an inspection task to verify a condition of the machine (e.g., using an optical sensor to verify that machine mechanisms are in expected states), reading and reporting a metered value, or other such tasks.

If the plant facility operates a fleet of robots 502 having different capabilities, the analysis component 212 can match a given maintenance task or with a robot 502 having the requisite functionality to complete the task (e.g., the appropriate sensing equipment, tooling arms, manipulation arms, etc.). To assist in matching an available robot 502 with an open maintenance task, the system 202 can maintain, for each robot 502, capability information defining the robot's functional capabilities, as well as schedule information indicating the robot's current or planned work schedule.

During the process of executing a robot-assisted work order 222, the robot 502 can provide the work order management system 202 with any suitable information that may be useful to the analysis component 212 in connection with dynamically planning and guiding the maintenance assistance activities of the robot 502, or coordinating the maintenance activities of multiple robots 502. This information can include, for example, robot location data 904 that identifies the robot's current location within the plant facility, additional asset data 504 collected by the robot 502 during execution of its maintenance tasks, or other such information. The robot 502 can also generate and send responses 906 to requests or prompts from the work order management system 202 for specific information (e.g., requests for status updates regarding the task assigned to the robot 502).

During execution of a work order 222, the monitoring component 210 can monitor the actions of both the assigned technicians as well as any robots 502 that have been instructed to assist with the work order's maintenance tasks. Bast on the aggregate status of the work order, as determined based on this monitoring, the analysis component 212 may dynamically update a robot's workflow instructions 902 to accommodate unforeseen circumstances reflected by the aggregated status, such as an unexpected delay in completion of one of the tasks defined by the work order 222, an inability to locate a required tool or replacement part, an unexpected change in the asset's health status, or other such circumstances. In response to such circumstances, the analysis component 212 can determine an updated strategy for completing the tasks defined by the work order 222 and send new workflow instructions 902 to the robot 502 that reflect the updated strategy.

The monitoring component 210 can also monitor performance metrics of the robot 502 during execution of its assigned maintenance task, including but not limited to the amount of time taken by the robot 502 to perform its task or to perform any intermediate steps of the task (e.g., traversal to a maintenance site, traversal to a tool storage location, performance of the a maintenance action, etc.), any deviations from the maintenance workflow due to unforeseen situations (e.g., inability to find a tool or part at its expected location, closure of a route within the plant that the robot 502 must traverse in order to reach the maintenance site or location of a tool, etc.), or other such metrics.

Some embodiments of the analysis component 212 can formulate a strategy for completing a set of open work orders 222 such that the strategy optimizes one or more maintenance metrics, or satisfies one or more defined optimization criteria. In such embodiments, the analysis component 212 can determine work order execution strategies that at least one of maximize overall maintenance efficiency, minimize the total time to execute the open work orders 222, minimize labor costs associated with execution of the work orders 222, minimize the number of technicians or robots 502 required to complete the work orders 222, minimize the number of steps taken by the technicians or robots 502 to complete the work orders 222, or optimize other such factors. The analysis component 212 can formulate these strategies based on aggregate analysis of the work orders 222 themselves (including the identities of the assets to which the respective work orders 222 are directed, the type of maintenance to be performed, etc.) as well as other plant-specific information such as the locations of the industrial assets within the plant facility (which can be obtained from the plant model 414 or from another source of asset location information), technician schedule and skill set information (which can be obtained by the MES interface component 214 as part of MES data 416, or from another source of technician information), the numbers and capabilities of robots 502 available to assist with execution of the work orders 222, plant operating schedules or operating schedules for individual lines or assets, or other such data. In some embodiments, the analysis component 212 can also reference information contained in trained models 412 (or the training data 802 itself) in connection with formulating optimized strategies for executing open work orders 222. The analysis component 212 can formulate the workflow instructions 902 sent to the robots 502 based on these optimized overall maintenance strategies.

By integrating mobile industrial robots into the process of identifying asset performance issues and carrying out maintenance to mitigate these issues, embodiments of the work order management system 202 described herein can reduce the maintenance burden on technicians, reduce total maintenance time, and improve the response time from occurrence of a performance risk to mitigation of that risk.

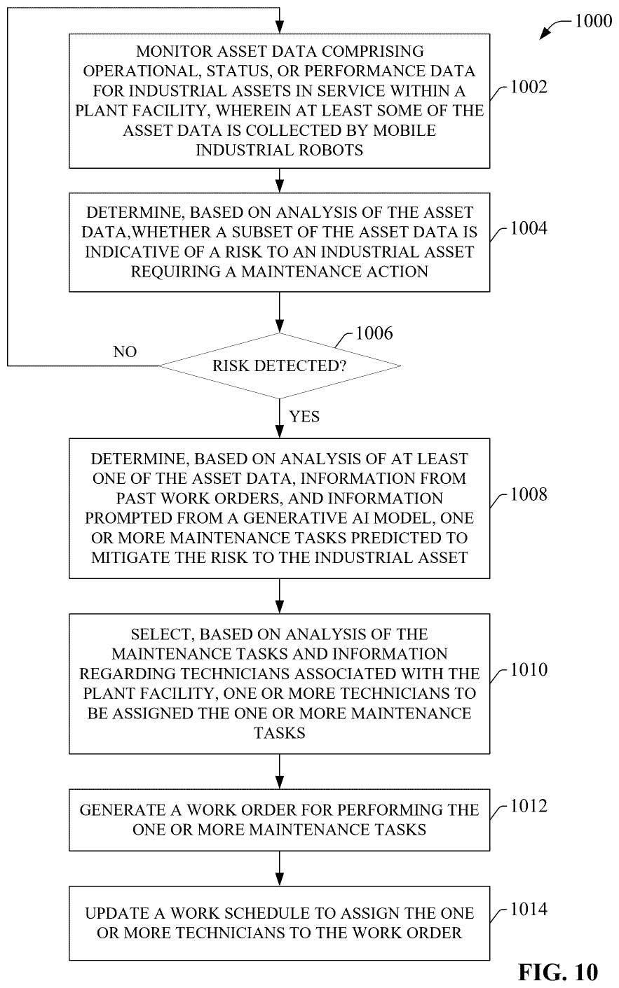

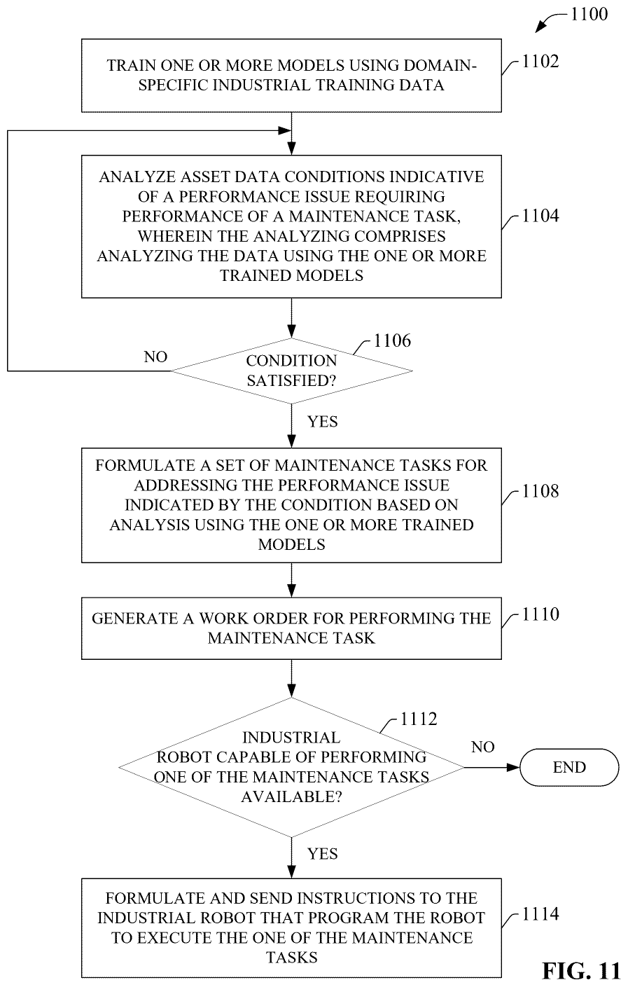

FIGS. 10-11 illustrate example methodologies in accordance with one or more embodiments of the subject application. While, for purposes of simplicity of explanation, the methodologies shown herein is shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 10 illustrates an example methodology 1000 for generating work orders in response to a detected risk to an industrial asset. Initially, at 1002, asset data comprising operational, status, or performance data generated by industrial assets in service within a plant facility is monitored. The asset data can be collected from data tags or automation objects defined on an industrial controller, sensors, telemetry devices, or other industrial devices that monitor or control automation systems in which the industrial assets are used. The collected data represents operational, status, or health information measured for the automation system, and may comprise telemetry values obtained from meters or sensors, status information read from sensors or smart devices (e.g., variable frequency drives), or other such data. The data may be collected by a gateway device that reads the data from the industrial devices and sends the data to a work order management system for monitoring and processing. At least some of this asset data can also be collected by, and a received from, mobile industrial robots capable of obtaining asset status or performance measurements using on-board sensors or data reading capabilities (e.g., near-field communication links, presence sensors, time-of-flight cameras or other types of three-dimensional sensors, heat sensors, etc.).

At 1004, a determination is made as to whether a subset of the asset data monitored at step 1002 is indicative of a risk to an industrial asset requiring a maintenance action. In this regard, the work order management system that performs the asset data monitoring can be configured to recognize when one or more of the monitored data values fall outside an expected range suggestive of normal operation of the automation system, or when trends in the monitored data are indicative of a predicted asset failure or performance problem that requires investigation or correction by maintenance personnel. In some embodiments, the system can make this determination based on an analysis of the asset data together with models trained with asset- and plant-specific training data. This training data can include, but is not limited to, knowledge or technical specifications of industrial assets, machines, and devices that are in service within the industrial facility; information from past or closed work orders for maintenance performed on the assets; monitored trends in asset operation (e.g., histories and frequencies of asset failure); information about technicians employed by the plant facility (e.g., employee identities, skill sets, work histories relative to specific assets or types of maintenance tasks, work schedules etc.); financial data for the plant facility; or other such training data.

Also, in some embodiments the system can leverage generative AI in connection with determining whether values or trends in the asset data are indicative of a current or future asset failure or performance issue. For example, as the asset data is being monitored, the system can generate and submit prompts to a generative AI model that are designed to obtain responses from the generative AI model that can assist in determining whether an industrial asset's performance data is indicative of a current or predicted failure or performance degradation. The system can use the content of the generative AI model's responses in connection with determining whether the asset's data is indicative of a risk. When formulating such prompts, the system can include any relevant information in the prompt that can assist the generative AI model in generating relevant and useful responses that can be used to improve the accuracy of the risk detection, including but not limited to a selected subset of the monitored asset data itself, an identity of the type of industrial asset of interest or the type of industrial process or application being carried out by the industrial asset, or other such data.

At 1006, a determination is made as to the a risk is detected based on the monitoring and determination steps 1002 and 1002. If no risk is detected (NO at step 1006, the methodology returns to step 1002 and the monitoring continues. If an asset risk is detected (YES at step 1006), the methodology proceeds to step 1008, where the system determines or formulates one or more maintenance tasks that are predicted to mitigate the detected risk. This determination can be based on an analysis of at least one of the asset data itself, information from past work orders (such as past work orders for maintenance that was performed on the asset experiencing the risk conditions), and information prompted from the generative AI model. As in the previous step, the system can generate prompts for submission to the generative AI model that are designed to obtain responses that can be used to infer suitable maintenance tasks having a high probability of addressing the asset risk detected at step 1006.

At 1010, the system selects one or more technicians to be assigned the one or more maintenance tasks based on analysis of the maintenance tasks determined at step 1008 and information regarding the set of technicians associated with the plant facility. The information about the technicians can comprise, for example, identities of the technicians registered to perform maintenance within the facility, the work schedules of those technicians, information regarding the technician's skill sets, or other such information. The system can also generate information about technicians' levels of experience in addressing various types of maintenance tasks (or levels of experience in working on a specific asset within the plant) based on analysis of closed or past work orders that had been assigned to the respective technicians and assign maintenance tasks to selected technicians based on this information regarding the technicians' relative levels of relevant work experience. In some embodiments, a determination can also be made as to whether one or more of the maintenance tasks can be carried out by a mobile industrial robot operated by the industrial facility and available to perform the tasks, or whether the industrial robot is capable of assisting a technician with performance of his or her task (e.g., by retrieving tools or replacement parts required to complete the technician's task). If so, the system can send instructions to the robot to carry out the maintenance tasks or to perform the assistance operation.

At 1012, a work order for performing the one or more maintenance tasks determined at step 1008 is generated by the system. In some embodiments, the system can generate content of the work order (e.g., descriptions of the discovered asset risk detected at step 1006 as well as the maintenance tasks determined at step 1008 for mitigating the risks) based on information obtained or analyzed in previous steps, and can also generate a portion of the content with the assistance of the generative AI model. At 1014, the work order management system updates a work schedule to assign the one or more technicians selected at step 1010 to the work order.

FIG. 11 illustrates an example methodology 1100 for using trained models to detect actionable risk conditions in industrial assets and to generate work orders to address these risk conditions. Initially, at 1102, one or more models are trained using domain-specific industrial training data comprising at least one of technical information for industrial assets that are in service within an industrial facility, information from closed work orders that were performed within the plant facility on the industrial assets, learned trends in performance metrics for the industrial assets, information about technicians employed by the industrial facility, or financial information for the plant facility. In some embodiments, rather than training models, the training data can be aggregated and store in one or more databases or knowledgebases and made accessible for use in detecting actionable risk conditions in industrial assets and to generating work orders.

At 1104, asset data comprising operational, status, or performance data generated by industrial assets in service within the plant facility are analyzed for conditions indicative of a performance issue requiring performance of a maintenance task, where this analysis is performed using the one or more models trained at step 1102 (or otherwise leveraging the domain-specific industrial data). In some embodiments, this analysis of the asset data can leverage generative AI to assist in determining whether values or trends in the monitored asset data are indicative of an actionable performance problem. For example, the system performing the analysis can formulate prompts directed to a generative AI model that are designed to obtain responses that can assist the system in interpreting values or trends in the asset data and determining whether these values or trends are indicative of a current or predicted performance concern in any of the monitored industrial assets. At least some of the asset data analyzed at step 1104 can be collected by, and received from, mobile industrial robots capable of measuring and retrieving status information for industrial assets and systems within the plant facility.

At 1106, a determination is made, based on the analysis at step 1104, as to whether the condition indicative of the performance issue is satisfied. If the condition is not satisfied (NO at step 1106), the methodology returns to step 1104 and the analysis continues. Alternatively, if the condition is satisfied (YES at step 1106), the methodology proceeds to step 1108, where a maintenance task for addressing the detected performance issues is formulated based on analysis using the one or more trained models. In some embodiments, the formulation of the maintenance task can be assisted using generative AI; e.g., by formulating and submitting prompts to a generative AI model that are designed to yield responses that can assist in identifying suitable maintenance tasks having a high probability of mitigating the detected risks. At 1110, a work order for performing the maintenance task formulated at step 1108 is generated. At least some of the content of the work order, such as the description of the detected maintenance concern and the description of the maintenance task, can be generated with the assistance of the generative AI model.

At 1112, a determination is made as to whether a mobile industrial robot capable of performing one of the maintenance tasks formulated at step 1108 is available. In this regard, the functional capabilities of the robot can be compared with the functional requirements of respective maintenance tasks defined by the work order, and based on this comparison a determination can be made as to whether the robot is capable of performing the task. The robot's scheduled availability at the time the task is to be performed can also be considered. If the robot is determined to be available at the necessary time and capable of performing the task (YES at step 1112, the methodology proceeds to step 1114, where instructions are formulated and sent to the robot, where these instructions program the robot to execute the maintenance task.

Embodiments, systems, and components described herein, as well as control systems and automation environments in which various aspects set forth in the subject specification can be carried out, can include computer or network components such as servers, clients, programmable logic controllers (PLCs), automation controllers, communications modules, mobile computers, on-board computers for mobile vehicles, wireless components, control components and so forth which are capable of interacting across a network. Computers and servers include one or more processors-electronic integrated circuits that perform logic operations employing electric signals-configured to execute instructions stored in media such as random access memory (RAM), read only memory (ROM), a hard drives, as well as removable memory devices, which can include memory sticks, memory cards, flash drives, external hard drives, and so on.

Similarly, the term PLC or automation controller as used herein can include functionality that can be shared across multiple components, systems, and/or networks. As an example, one or more PLCs or automation controllers can communicate and cooperate with various network devices across the network. This can include substantially any type of control, communications module, computer, Input/Output (I/O) device, sensor, actuator, and human machine interface (HMI) that communicate via the network, which includes control, automation, and/or public networks. The PLC or automation controller can also communicate to and control various other devices such as standard or safety-rated I/O modules including analog, digital, programmed/intelligent I/O modules, other programmable controllers, communications modules, sensors, actuators, output devices, and the like.

The network can include public networks such as the internet, intranets, and automation networks such as control and information protocol (CIP) networks including DeviceNet, ControlNet, safety networks, and Ethernet/IP. Other networks include Ethernet, DH/DH+, Remote I/O, Fieldbus, Modbus, Profibus, CAN, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

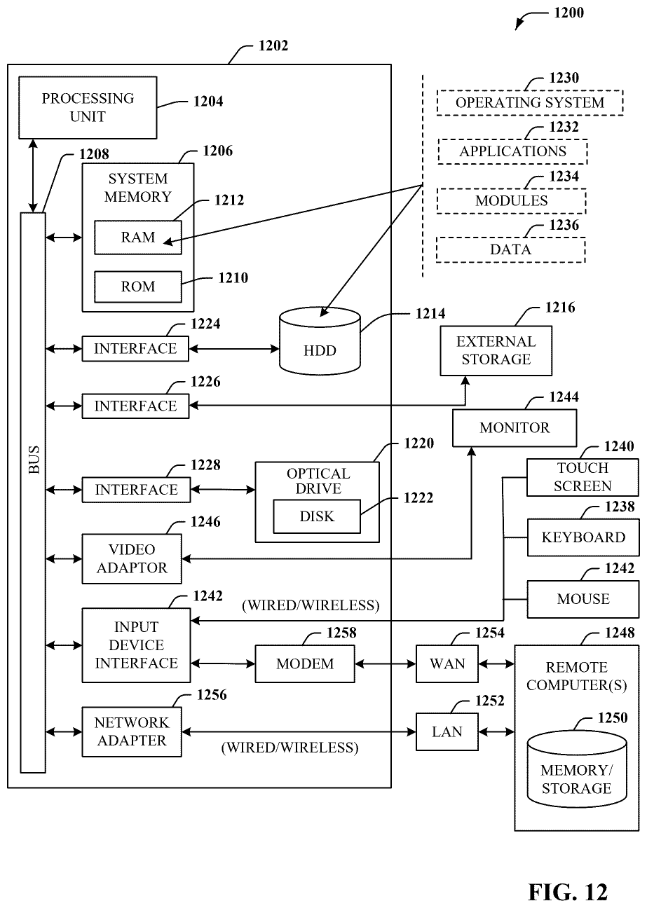

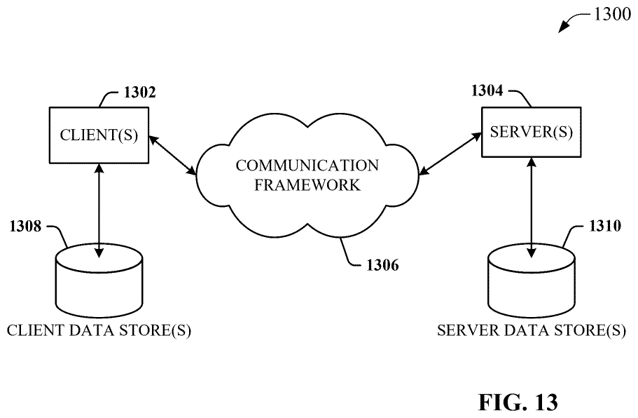

In order to provide a context for the various aspects of the disclosed subject matter, FIGS. 12 and 13 as well as the following discussion are intended to provide a brief, general description of a suitable environment in which the various aspects of the disclosed subject matter may be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12 the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for application programs 1232. Runtime environments are consistent execution environments that allow application programs 1232 to run on any operating system that includes the runtime environment. Similarly, operating system 1230 can support containers, and application programs 1232 can be in the form of containers, which are lightweight, standalone, executable packages of software that include, e.g., code, runtime, system tools, system libraries and settings for an application.

Further, computer 1202 can be enable with a security module, such as a trusted processing module (TPM). For instance with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1244 or other type of display device can be also connected to the system bus 1208 via an interface, such as a video adapter 1246. In addition to the monitor 1244, a computer typically includes other peripheral output devices (not shown), such as speakers, printers, etc.

The computer 1202 can operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1252 through a wired and/or wireless communication network interface or adapter 1256. The adapter 1256 can facilitate wired or wireless communication to the LAN 1252, which can also include a wireless access point (AP) disposed thereon for communicating with the adapter 1256 in a wireless mode.

When used in a WAN networking environment, the computer 1202 can include a modem 1258 or can be connected to a communications server on the WAN 1254 via other means for establishing communications over the WAN 1254, such as by way of the Internet. The modem 1258, which can be internal or external and a wired or wireless device, can be connected to the system bus 1208 via the input device interface 1242. In a networked environment, program modules depicted relative to the computer 1202 or portions thereof, can be stored in the remote memory/storage device 1250. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1252 or WAN 1254 e.g., by the adapter 1256 or modem 1258, respectively. Upon connecting the computer 1202 to an associated cloud storage system, the external storage interface 1226 can, with the aid of the adapter 1256 and/or modem 1258, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 13 is a schematic block diagram of a sample computing environment 1300 with which the disclosed subject matter can interact. The sample computing environment 1300 includes one or more client(s) 1302. The client(s) 1302 can be hardware and/or software (e.g., threads, processes, computing devices). The sample computing environment 1300 also includes one or more server(s) 1304. The server(s) 1304 can also be hardware and/or software (e.g., threads, processes, computing devices). The servers 1304 can house threads to perform transformations by employing one or more embodiments as described herein, for example. One possible communication between a client 1302 and servers 1304 can be in the form of a data packet adapted to be transmitted between two or more computer processes. The sample computing environment 1300 includes a communication framework 1306 that can be employed to facilitate communications between the client(s) 1302 and the server(s) 1304. The client(s) 1302 are operably connected to one or more client data store(s) 1308 that can be employed to store information local to the client(s) 1302. Similarly, the server(s) 1304 are operably connected to one or more server data store(s) 1310 that can be employed to store information local to the servers 1304.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

What is claimed is:

1. A system, comprising:
a memory that stores executable components and work order data defining closed work orders for maintenance tasks that have been completed; and
a processor, operatively coupled to the memory, that executes the executable components, the executable components comprising:
a device interface component configured to receive industrial asset data collected by a mobile industrial robot within an industrial facility, wherein the industrial asset data comprises operational and status information for the industrial assets;
an analysis component configured to, in response to a determination, based on analysis of the industrial asset data, that a subset of the industrial asset data satisfies a condition indicative of a current or predicted risk to an industrial asset of the industrial assets, formulate one or more maintenance tasks predicted to mitigate the current or predicted risk; and
a work order generation component configured to, in response to the determination by the analysis component that the subset of the industrial data satisfies the condition, generate a work order prescribing the one or more maintenance tasks.

2. The system of claim 1, wherein
the mobile industrial robot is a first mobile industrial robot,
the analysis component is further configured to:
determine, based on capability data describing functional capabilities of a second mobile industrial robot, whether the second mobile industrial robot is capable of performing a maintenance task of the one or more maintenance tasks, and
in response to a determination that the second mobile industrial robot is capable of performing the maintenance task, formulate robot instructions that program the second mobile industrial robot to perform the maintenance task, and
the device interface component is further configured to send the robot instructions to the second mobile industrial robot.

3. The system of claim 3, wherein the maintenance task is at least one of retrieval of a tool required to perform at least one of the one or more maintenance tasks, measurement of a status or performance metric of the industrial asset, performance of a tooling action, operation of a panel control, movement of a component part or material, or verification of a condition of the industrial asset.

4. The system of claim 1, wherein the analysis component is configured to, as part of the analysis, generate a prompt, directed to a generative artificial intelligence (AI) model, designed to obtain a response from the generative AI model that is used by the analysis component to determine whether the subset of the industrial asset data satisfies the condition.

5. The system of claim 4, wherein
the response from the generative AI model is a first response, and
the analysis component is further configured to formulate the one or more maintenance tasks based on second responses prompted from the generative AI model.

6. The system of claim 1, wherein the analysis component is further configured to determine whether the subset of the industrial asset data satisfies the condition based on a model trained with training data comprising at least one of technical specification data for the industrial assets, information from past work orders that were generated for the industrial assets, historical operational or status data for the industrial assets, information about technicians employed by the plant facility, or financial data for the plant facility.

7. The system of claim 1, wherein the analysis component is further configured to formulate the one or more maintenance tasks based on content of a plant model that defines the industrial assets in service within the plant facility, functional relationships between the industrial assets, and geographical relationships between the industrial assets.

8. The system of claim 1, wherein
a subset of the industrial asset data comprises an identity of a new industrial asset discovered by the mobile industrial robot that is not registered with the system, and
the analysis component is further configured to register the new industrial asset in the system in response to receipt of the subset of the industrial asset data.

9. The system of claim 1, wherein the analysis component is configured to learn the condition indicative of the current or predicted risk based on analysis of trends in the industrial asset data over time.

10. The system of claim 1, further comprising a user interface configured to render content of the work order generated by the work order generation component, wherein the content comprises at least one of a description of the current or predicted risk, descriptions of the one or more maintenance tasks, identities of one or more technicians assigned to the work order, a status of the work order, a priority of the work order, or an identity of the industrial asset.

11. The system of claim 1, wherein the mobile industrial robot is configured to collect the industrial asset data using at least one of a near-field communication link that reads data from an industrial device or meter, a three-dimensional camera, a heat sensor, a presence sensor, or a motion amplification sensor.

12. A method, comprising:
receiving, by a system comprising a processor, industrial asset data collected by a mobile industrial robot within an industrial facility, wherein the industrial asset data comprises operational and status information for the industrial assets; and
in response to determining, based on analysis of the industrial asset data, that a subset of the industrial asset data satisfies a condition indicative of a current or predicted risk to an industrial asset of the industrial assets:
determining, by the system, one or more maintenance tasks predicted to mitigate the current or predicted risk; and
generating a work order prescribing the one or more maintenance tasks.

13. The method of claim 12, wherein
the mobile industrial robot is a first mobile industrial robot, and
the method further comprises:
determining, by the system based on capability data describing functional capabilities of a second mobile industrial robot, whether the second mobile industrial robot is capable of performing a maintenance task of the one or more maintenance tasks, and
in response to a determination that the second mobile industrial robot is capable of performing the maintenance task, formulating, by the system, robot instructions that program the second mobile industrial robot to perform the maintenance task, and
sending, by the system, the robot instructions to the second mobile industrial robot.

14. The method of claim 12, wherein the maintenance task is at least one of retrieval of a tool required to perform at least one of the one or more maintenance tasks, measurement of a status or performance metric of the industrial asset, performance of a tooling action, operation of a panel control, movement of a component part or material, or verification of a condition of the industrial asset.

15. The method of claim 12, as part of the analysis, generate a prompt, directed to a generative artificial intelligence (AI) model, designed to obtain a response from the generative AI model that is used by the analysis component to determine whether the subset of the industrial asset data satisfies the condition

16. The method of claim 15, wherein
the response from the generative AI model is a first response, and
the determining of the one or more maintenance tasks comprises determining the one or more maintenance tasks based on second responses prompted from the generative AI model.

17. The method of claim 11, further comprising determining whether the subset of the industrial asset data satisfies the condition based on a model trained with training data comprising at least one of technical specification data for the industrial assets, information from past work orders that were generated for the industrial assets, historical operational or status data for the industrial assets, information about technicians employed by the plant facility, or financial data for the plant facility.

18. The method of claim 11, wherein the mobile industrial robot is configured to collect the industrial asset data using at least one of a near-field communication link that reads data from an industrial device or meter, a three-dimensional camera, a heat sensor, a presence sensor, or a motion amplification sensor.

19. A non-transitory computer-readable medium having stored thereon instructions that, in response to execution, cause a work order management system comprising a processor to perform operations, the operations comprising:
receiving industrial asset data collected by a mobile industrial robot within an industrial facility, wherein the industrial asset data comprises operational and status information for the industrial assets;
in response to determining, based on analysis of the industrial asset data, that a subset of the industrial asset data satisfies a condition indicative of a current or predicted risk to an industrial asset of the industrial assets:
formulating one or more maintenance tasks predicted to mitigate the current or predicted risk; and
generating a work order prescribing the one or more maintenance tasks.

20. The non-transitory computer-readable medium of claim 19, wherein
the mobile industrial robot is a first mobile industrial robot, and
the operations further comprise:
determining, based on capability data describing functional capabilities of a second mobile industrial robot, whether the second mobile industrial robot is capable of performing a maintenance task of the one or more maintenance tasks, and
in response to a determination that the second mobile industrial robot is capable of performing the maintenance task, formulating robot instructions that program the second mobile industrial robot to perform the maintenance task, and
sending the robot instructions to the second mobile industrial robot.
